(19) United States
(12) Patent Application Publication
(10) Pub. No.: US 2006/0203758 A1
(43) Pub. Date: Sep. 14, 2006

(54) Mobile terminal for relaying multimedia data to an external display device

(75) Inventors: Lai King Tee, Dallas, TX (US); Cornelius van Rensburg, Dallas, TX (US); Joseph R. Cleveland, Murphy, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/237,357

(22) Filed: Sep. 27, 2005

Related U.S. Application Data
(60) Provisional application No. 60/661,267, filed on Mar. 11, 2005.

(51) Int. Cl. G06F 15/16; H04J 3/08; H04B 7/14; H04J 1/10

(52) U.S. Cl. 370/315; 709/227

(57) ABSTRACT

A mobile terminal comprising a local display for displaying multimedia data. The mobile terminal receives multimedia data via a first wireless interface and transmits the received multimedia data to an external display via a second wireless interface. The mobile terminal transmits the received multimedia data to the external display if the mobile terminal determines the quality of the external display is superior to the quality of the local display.

### CROSS-REFERENCE TO RELATED APPLICATION AND CLAIM OF PRIORITY

The present application is related to U.S. Provisional Patent No. 60/661,267, filed Mar. 11, 2005, entitled “Mobile Device For Downloading, Relaying And Distributing Multimedia Applications”. U.S. Provisional Patent No. 60/661,267 is assigned to the assignee of the present application and is hereby incorporated by reference into the present disclosure as if fully set forth herein. The present application hereby claims priority under 35 U.S.C. §119(e) to U.S. Provisional Patent No. 60/661,267.

### TECHNICAL FIELD OF THE INVENTION

The present application relates generally to wireless communications and, more specifically, to a wireless mobile terminal that relays video and other data to peripheral devices.

### BACKGROUND OF THE INVENTION

Wireless mobile terminals are being used in an ever-increasing variety of applications. This is particularly true of hand-held devices, such as cell phones, personal digital assistant (PDA) devices with wireless capability, and wireless hand-held (or palm top) computers. More and more, these applications include video and/or audio applications or multimedia applications that rely heavily on graphics. Previous generations of hand-held mobile terminals were capable of supporting multimedia and video/audio applications, but this capability was diminished by the relatively low data rates that conventional wireless networks could achieve. This problem is being addressed by new wireless communications standards and equipment that provide much higher data rates.

However, even if network bottlenecks are removed, the usefulness of small mobile terminals may be limited nonetheless by the human interface problems associated with handheld devices. The small display screens of wireless mobile terminals diminish the capabilities of some applications, particularly video applications. For example, the small screens of hand-held mobile terminals are a well-known hindrance to the display of website information in Internet browser applications. As a practical matter, the display of a mobile terminal (e.g., a cell phone or PDA) typically has size limitations imposed by form-factor, power consumption and cost. Thus, handheld mobile terminals may not be an attractive device for some video and multimedia applications.

Therefore, there is a need in the art for small mobile terminals that are better suited to video applications and to multimedia applications. In particular, there is a need for a mobile terminal that can overcome the limitations of a small display screen to provide improved viewing of video and multimedia applications.

### SUMMARY OF THE INVENTION

A mobile terminal is provided. According to an advantageous embodiment, the mobile terminal comprises a local display capable of displaying multimedia data, a controller capable of transmitting the multimedia data to the local display, and a first transceiver capable of communicating with a remote display device. The controller is capable of comparing display parameter information associated with the external display device to display parameter information associated with the local display and, in response to the comparison, transmitting the multimedia data to the external display device via the first transceiver.

A method of operating a remote terminal is also provided. The method comprises transmitting multimedia data to a local display of the remote terminal, detecting the presence of a remote display device, establishing a wireless communication link with the remote display device, comparing display parameter information associated with the remote display device to display parameter information associated with the local display, and, in response to the comparison, transmitting the multimedia data to the remote display device.

Another mobile terminal is provided comprising a local display capable of displaying multimedia data. The mobile terminal is capable of receiving multimedia data via a first wireless interface and transmitting the received multimedia data to an external display via a second wireless interface. The mobile terminal transmits the received multimedia data to the external display if the mobile terminal determines the quality of the external display is superior to the quality of the local display.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary mobile terminal operating in a network environment according to one embodiment of the disclosure;

FIG. 2 illustrates the exemplary mobile terminal in FIG. 1 in greater detail according to one embodiment of the disclosure; and

FIG. 3 is a flow diagram illustrating the operation of the exemplary mobile terminal and a remote display device according to one embodiment of the disclosure.

### DETAILED DESCRIPTION OF THE INVENTION

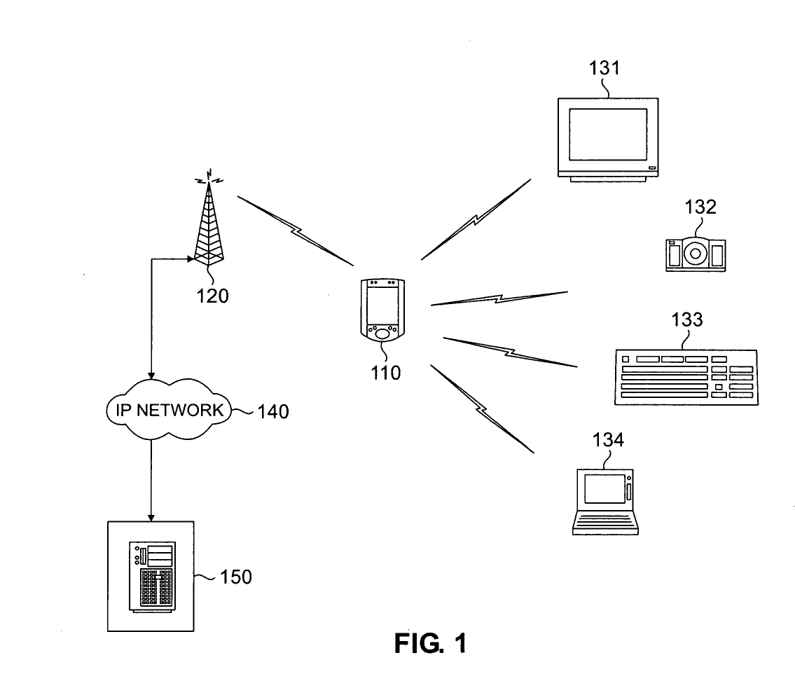

FIGS. 1 through 3, discussed below, and the exemplary embodiments described in the disclosure are by way of illustration only and should not be construed in any way to limit the scope of the disclosure. Those skilled in the art will understand that the principles of the present disclosure may be implemented in any suitably arranged wireless mobile terminal.

The mobile terminal disclosed herein overcomes the limitations of a small display screen by receiving video data (i.e., display data) over a first wireless interface and transmitting (or relaying) the video data over a second wireless interface to an external (or remote) device having a better (bigger) display, such as a television, a computer monitor, a laptop computer, the dashboard display of a car, a video projection device, and the like. For the purposes of this disclosure and the claims herein, the video data, which may also be referred to as multimedia data, is defined to include not only the video data itself, but may also include the audio data, text data, and control data that may accompany the video data.

In some instances, the determination of whether the remote device has a better display may depend on the requirements of the video application executed by the mobile terminal. For many applications, it may be assumed that displays that are larger and have higher resolutions are better displays. The mobile terminal user may also make the decision as to which display to use.

Generally, the first wireless interface supports mobile wireless communications, including, but not limited to IS-2000, 1xEV-DO, 1xEV-DV, GSM/GPRS/EDGE, 3GPP UTRAN, HSDPA/HSUPA, 3GPP EUTRAN, TD-CDMA, WiBro, WiMAX, IEEE-802.16x, IEEE-802.20, and IEEE-802.11x (e.g., WiFi) in a hotspot environment. The second wireless interface typically supports shorter range wireless communications, including, but not limited to IEEE-802.15.3x, MB-OFDM, UWB, Wireless USB, IEEE-802.11x (or WiFi), and a Bluetooth standard that supports high throughput applications.

An exemplary mobile terminal may be used for mobile communications and as a gateway for a short-range wireless network, also called a personal area network (PAN). The mobile terminal may support a variety of mobile applications, including voice, multimedia (i.e., video, graphics, text, and audio downloads), video conferencing, web browsing, file download, VPN and Internet gaming. Advantageously, when the mobile terminal is near a higher quality display (e.g., a TV screen), the mobile terminal relays its video data to the external display device as well as to its internal display. This enables the operator of the mobile terminal to view the information on the higher quality display device, and to share the displayed information with other people at the same location, e.g., in a video conference call, or watching the latest broadcasting and streaming of News or events of common interests. Note that in the latter example, the source of information could be a remote Internet web server instead of a conventional TV broadcasting station. A remote Internet web server does not have the same geographical coverage limit as a conventional TV broadcasting station. In the case of group video conferencing using, for example, a digital camera phone, it would be more practical and ergonomically correct to have the received video data displayed on an external screen, while the phone camera captures and transmits the local user images.

FIG. 1 illustrates exemplary mobile terminal 110 operating in a network environment according to an exemplary embodiment of the disclosure. Mobile terminal 110 is depicted in FIG. 1 as a PDA type device. However, this depiction is by way of illustration only and should not be construed so as to limit the scope of the present disclosure. In fact, mobile terminal (MT) 110 may be any type of mobile wireless device that uses a display, including a cellular phone, a PDA, a handheld computer (e.g., Pocket PC™), and even a laptop computer. As an alternative, this mobile terminal may not need to have a high resolution, high quality display, as it could make use of external display device.

Mobile terminal 110 is capable of communicating with one or more types of wireless wide-area networks (WANs), including conventional cellular networks and wireless local area networks (WLANs). By way of example, mobile terminal 110 may communicate with base station (BS) 120, which may be associated with a CDMA2000/1xEV-DO/1xEV-DV network, a GSM/GPRS/EDGE network, an IEEE-802.16x network, or the like. In other embodiments, base station 120 may communicate according to such wireless interface standards, or their evolutions, as 1xEV-DO, 1xEV-DV, GSM/GPRS/EDGE, 3GPP UTRAN, HSDPA/HSUPA, 3GPP EUTRAN, TD-CDMA, WiBro, WiMAX, IEEE-802.20, or IEEE-802.11x, among others. Base station 120 provides mobile terminal 110 with access to voice networks, such as the public switched telephone network (PSTN), and to data networks, including, for example, the Internet or proprietary Internet protocol (IP) networks. In the illustrated embodiment, BS 120 provides mobile terminal 110 with access to server 150 via IP network 140.

Mobile terminal 110 is also capable of communicating with one or more types of external (or remote) devices via a short-range wireless interface standard, such as IEEE-802.11x, ultra-wideband (UWB), IEEE-802.15.3x, MB-OFDM, Wireless USB, or a Bluetooth standard that supports high throughput applications, among others. It is assumed for the purposes of this disclosure that any such remote device comprises a wireless transceiver that can communicate with mobile terminal 110 in order to establish a personal area network (PAN) connection. By way of example, mobile terminal 110 may communicate with television 131 (or computer monitor 131), projector 132, keyboard 133, and laptop (or handheld) personal computer (PC) 134. If the remote device is capable of displaying video (e.g., television 131), it is assumed that the wireless transceiver of the remote device supports a relatively high data rate that is suitable for video applications and/or multimedia applications.

According to an advantageous embodiment, mobile terminal 110 may relay a video stream to a remote device in order to allow the operator of mobile terminal 110 to view the video on a better display. By way of example, mobile terminal 110 may be receiving streaming video data from server 150 via IP network 140 and base station 120. The streaming video is displayed on the display of mobile terminal 110. At some point, mobile terminal 110 may be located near to television 131 and establish a wireless communication link via the short-range wireless protocol (e.g., IEEE-802.11x/802.15.3x) with television 131. Mobile terminal 110 may then request information from television 131 regarding the capabilities of the display screen of television 131.

Assuming television 131 is a more desirable display than mobile terminal 110, mobile terminal 110 may relay the streaming video signal to television 131 via the short-range (or PAN) wireless communication link. This may be done automatically, or mobile terminal 110 may prompt the operator of mobile terminal 110 to select television 131 before relaying the video signal. Similarly, mobile terminal 110 may transmit a video signal over the short-range PAN connection to computer 134, projector 132, or any other remote device that has a display screen.

It is not required that mobile terminal 110 receive an incoming video stream from base station 120. In an alternate scenario, mobile terminal 110 may execute a video application and/or a multimedia application that plays back a video file and/or multimedia file stored in memory in mobile terminal 110. Mobile terminal 110 then transmits the video (or multimedia) stream from the stored file to television 131 (or another device) for viewing. Advantageously, mobile terminal 110 is also capable of establishing a communication link with keyboard 133 (or another input device such as an electronic notepad) via the short-range PAN connection in order to allow the operator of mobile terminal 110 to use keyboard 133 (or the other input device) in lieu of the keyboard or other control buttons on mobile terminal 110. By way of example, mobile terminal 110 may establish a Bluetooth connection to keyboard 133 in order to allow the operator to use keyboard 133 to control mobile terminal 110. In this scenario, the external keyboard, external display and the mobile terminal are connected in the form of a conventional computer, with air interface 1 connecting the computer (with the MT playing the role of the computing unit) to the Internet, and air interface 2 or 3 connecting the computer to the external keyboard and display. If air interface 2 can support both connections between the MT and keyboard or display simultaneously, it is not necessary to have air interface 3.

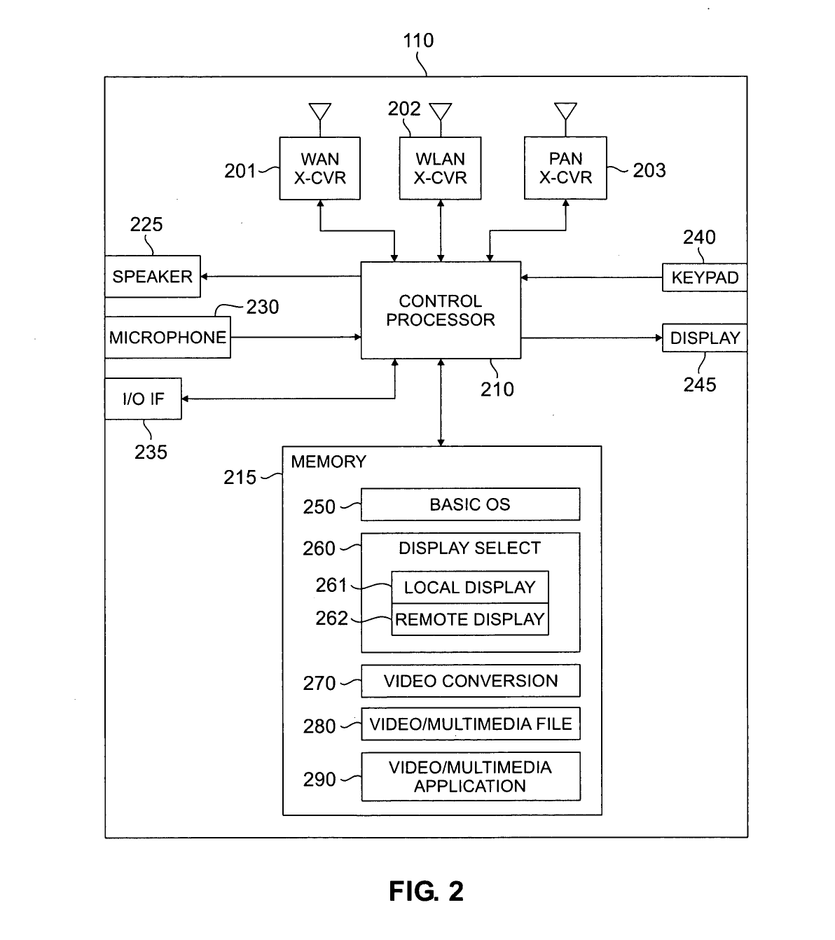

FIG. 2 illustrates exemplary mobile terminal 110 in greater detail according to an exemplary embodiment of the disclosure. Mobile terminal 110 comprises wide-area network (WAN) transceiver (X-CVR) 201, wireless local area network (WLAN) transceiver (X-CVR) 202, and personal area network (PAN) transceiver (X-CVR) 203. In an embodiment, only one of WLAN transceiver 202 and PAN transceiver 203 may be employed. Mobile terminal 110 also comprises control processor 210, memory 215, speaker 225, microphone 230, input/output interface (I/O IF) 235, keypad 240 and display 245. Memory 215 stores basic operating system (OS) program 250, display select program 260, video conversion program 270, video/multimedia file 280, and one or more video application programs 290. Display select program 260 comprises local display parameters file 261 and remote display parameters file 262.

Control processor 210 and memory 215 function as a controller that controls the overall operation of mobile terminal 110. Control processor 210 executes basic OS program 250 in order to control, among other things, transceivers 201, 202 and 203. Control processor 210 receives operator inputs from keypad 240 or another user input device (not shown) and displays data on display 245. If mobile terminal 110 is, for example, a cell phone, control processor 210 can receive a voice signal from microphone 230 and can send voice signals to speaker 225. I/O interface 235 allows control processor 210 to be coupled to, and communicate with, another device, including, for example, a docking station, a data cord, an operator input device, or the like.

In the exemplary embodiment, control processor 210 uses WAN transceiver 201 to communicate over a wide area network. For example, WAN transceiver 201 may be a GSM/GPRS/EDGE transceiver, a CDMA2000/1xEV-DO transceiver, or an IEEE-802.16x transceiver that communicates with base station 120 of a wide-area network. Control processor 210 may use WLAN transceiver 202 to communicate in a wireless local area network (WLAN) environment, such as an office WLAN that may have a coverage area or range of several hundred feet. By way of example, WLAN transceiver 202 may be an IEEE-802.11x transceiver. Control processor 210 may use PAN transceiver 203 to communicate in a personal area network (PAN) environment, such as a Bluetooth or IEEE-802.15.3 communication link that may have a coverage area or range around 10-20 meters.

In the illustrated embodiment in FIG. 2, three distinct transceivers are shown. However, this is by way of example only. In an alternate embodiment, mobile terminal 110 may communicate with BS 120 via a first air interface (or wireless interface) and with an external device that has a display screen via a second air interface (or wireless interface). Thus, mobile terminal 110 may comprise only two transceivers. Advantageously, one or more of transceivers 201-203 may be based on software-defined radio (SDR) technology and therefore may be capable of communicating according to more than one wireless interface standard.

Additionally, depending on the distances involved, mobile terminal 110 may receive an incoming video and/or multimedia stream from any one of WAN transceiver 201, WLAN transceiver 202, and PAN transceiver 203 and may relay the video and/or multimedia stream to an external device using, for example, WLAN transceiver 202 or PAN transceiver 203. Essentially, this air interface functions similarly to I/O interface 235, but over the wireless link.

In one example, mobile terminal 201 may receive a video stream from BS 120 via WAN transceiver 201 and may relay the video stream over a short distance to a remote display device via WLAN transceiver 202 or PAN transceiver 203. This may occur when mobile terminal 201 communicates with BS 120 in a cellular network and the remote display communicates with mobile terminal 110 using, for example, an IEEE-802.11x transceiver (i.e., communicates with WLAN transceiver 202) or a Bluetooth or IEEE-802.15.3x transceiver (i.e., communicates with PAN transceiver 203).

In another example, mobile terminal 201 may receive a video stream from a base station or access point of a home or office WLAN via WLAN transceiver 202 and may relay the video stream over a short distance to a remote display device via PAN transceiver 203. This may occur when the base station or access point in the office WLAN communicates with mobile terminal 110 using, for example, an IEEE-802.11x transceiver and the remote display communicates with mobile terminal 110 using, for example, a high data rate Bluetooth transceiver that is capable of supporting the required video data throughput.

In a third example, mobile terminal 201 may receive a video stream from a base station, an access point, or a video source device via PAN transceiver 203 and may relay the video stream over a short distance to a remote display device via WLAN transceiver 202. This may occur if the video source with wireless capability transmits a video stream to mobile terminal 110 using, for example, a high data rate Bluetooth transceiver and the remote display communicates with mobile terminal 110 using, for example, an IEEE-802.11x transceiver.

Control processor 210 executes video/multimedia application program 290 in order to display video data on display 245. Control processor 210 executes video conversion program 270 in order to re-format (if necessary) the video data downloaded from server 150 through the one wireless interface (e.g., WAN transceiver 201) to a suitable format for re-transmission via another wireless interface (e.g., WLAN transceiver 202 or PAN transceiver 203). Additionally, video/multimedia application program 290 may retrieve video/multimedia data from video/multimedia file 280 and transmit a video stream to a remote device via a wireless interface. Advantageously, the wireless interface may have more than one connection at the same time. For example, PAN transceiver 203 may transmit video to television 131 while simultaneously communicating with wireless keyboard 240.

Control processor 210 executes display select program 260 in order to determine whether the quality of the display of the remote device (e.g., television 131) is superior to the quality of display 245 in mobile terminal 110. Control processor 210 may execute display select program 260 automatically in response to detection of wireless signals transmitted by the remote device. For example, PAN transceiver 203 may detect a pilot (or similar beacon) signal transmitted by the wireless transceiver associated with television 131 and may send a notification signal to control processor 210. The pilot/beacon signal may be a signal broadcast by a device, such as television 131, for example, to provide notification of the presence and capabilities of the device and the services provided by the device. Upon receipt of the notification signal, control processor 210 may launch display select application program 260. In another embodiment, PAN transceiver 203 broadcasts a signal to discover and interrogate neighboring nodes that may have the ability to display the information. As an example, the wireless transceiver associated with television 131 may acquire the transmission from PAN transceiver 203 and may transmit a signal in response to the inquiry, using the protocol supported by the air interface standard. Alternatively, control processor 210 may execute display select program 260 in response to manual inputs entered by the operator of mobile terminal 110.

Under control of display select program 260, control processor 210 is capable of querying the remote device (e.g., television 131) to determine the quality of the display associated with the remote device, for example, by requesting the remote device to transmit parameters or attributes describing the capabilities of the remote device. If the attributes of the external display device are available, the data can be formatted accordingly before transmission through the second interface to the display device. However, it is not always necessary for the remote device to have the capability to respond to such an inquiry. Any standard protocol that is supported by the air interface would be sufficient for the mobile terminal to transmit the video data, and the similar air interface of the display device to receive, demodulate and decode the data. Nevertheless, it is assumed that the external display device has the capability to decode the received data and convert it to a signal/pixel format that is supported by the display mechanism, e.g., a MPEG4 decoder, and/or a Digital-to-Analog converter. Control processor 210 receives the display parameters associated with the remote device and stores these parameters in remote display parameters file 262. The parameters associated with display 245 are stored in local display parameters file 261. The parameter data may include, for example, display size, display type (CRT, LED, etc.), pixel size, refresh rate, and the like.

Under control of display select program 260, control processor 210 compares the parameters in remote display parameters file 262 to the parameters in local display parameters file 261 and selects the display best suited to video/multimedia application program 290. If the display of the external device is selected, control processor 210 transfers the video/multimedia data to the appropriate one of transceivers 202 and 203. Control processor 210 may prompt the operator of mobile terminal 110 for permission to transmit video/multimedia data to the remote display device. Control processor 210 may also continue to send video/multimedia data to display 245 for simultaneous display. In an alternate embodiment, it may be assumed that the remote display is better than display 245. In such an embodiment, control processor 210 may select the remote display (with or without operator permission) without comparing parameters associated with display 245 and the remote display.

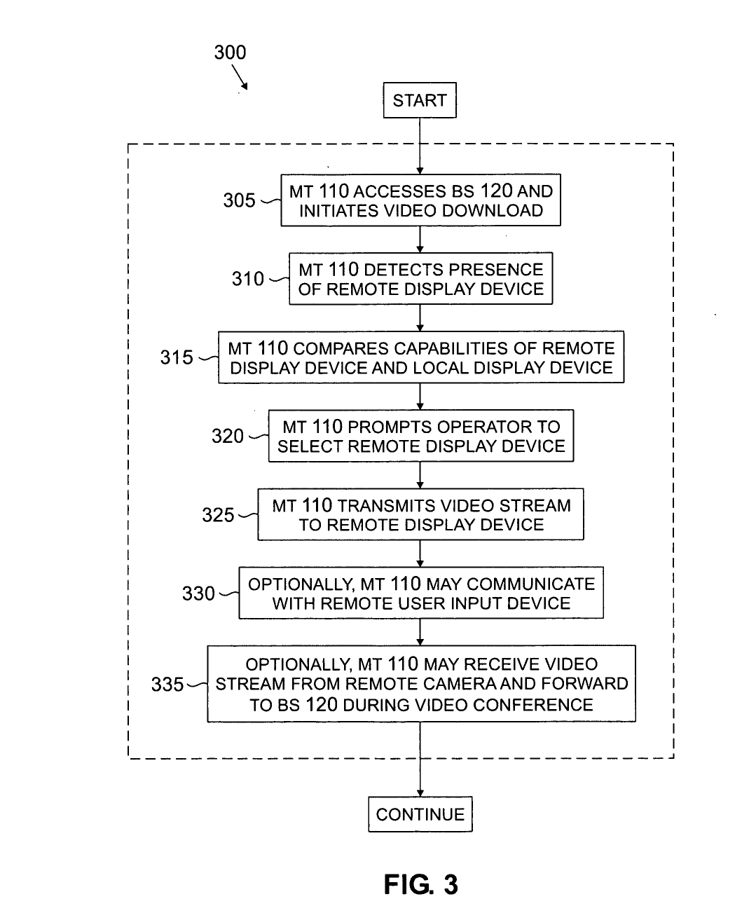

FIG. 3 depicts flow diagram 300, which illustrates the operation of exemplary mobile terminal 110 and a remote display device according to one embodiment of the disclosure. Initially, mobile terminal 110 accesses base station 120 via an air interface (e.g., transceiver 201 or 202) and initiates a video/multimedia download from server 150 (process step 305). Alternatively, mobile terminal 110 may play back video/multimedia data stored in video/multimedia file 280. At some point, mobile terminal 110 detects the presence of a remote display device (e.g., television 131) via another air interface (e.g., transceiver 202 or 203) and establishes a wireless link with the remote display device (process step 310), with the authorization of the mobile terminal user.

Mobile terminal 110 then requests the capabilities of the remote display device and compares the capabilities of the remote display device and local display 245 (process step 315). Mobile terminal 110 may prompt the operator to select the remote display device (process step 320). Assuming the remote display device is selected, mobile terminal 110 then forwards (or relays or re-transmits) the video stream from base station 120 (or video/multimedia file 280) to the remote display device (process step 325). Optionally, mobile terminal 110 may wirelessly communicate with a remote user input device, such as keyboard 133 process step 330). Optionally, if video/multimedia application program 290 is a video conferencing application, mobile terminal 110 receives via the short-range air interface video/multimedia data from a remote video camera and relays the camera video data to base station 120 (process step 335).

Although the present disclosure has been described with one or more exemplary embodiments, various changes and modifications may be suggested to one skilled in the art. It is intended that the present disclosure encompass such changes and modifications as fall within the scope of the appended claims.

What is claimed is:

1. A mobile terminal comprising:
a local display capable of displaying multimedia data;
a controller capable of transmitting the multimedia data to the local display; and
a first transceiver capable of communicating with a remote display device,
wherein the controller is capable of comparing display parameter information associated with the remote display device to display parameter information associated with the local display and, in response to the comparison, transmitting the multimedia data to the remote display device via the first transceiver.

2. The mobile terminal as set forth in claim 1, wherein the controller retrieves the multimedia data from a multimedia file stored in a memory associated with the controller.

3. The mobile terminal as set forth in claim 1, wherein the controller compares the display parameter information associated with the remote display device to the display parameter information associated with the local display in order to determine which of the remote display device and the local display is better suited to a multimedia application executed by the mobile terminal.

4. The mobile terminal as set forth in claim 3, wherein the controller is capable of communicating with a remote user input device via the first transceiver.

5. The mobile terminal as set forth in claim 4, wherein the remote user input device comprises a wireless keyboard.

6. The mobile terminal as set forth in claim 4, wherein the controller is capable of prompting an operator of the mobile terminal for permission to transmit the multimedia data to the remote display device via the first transceiver.

7. The mobile terminal as set forth in claim 4, wherein the first transceiver comprises a personal area network transceiver.

8. The mobile terminal as set forth in claim 4, wherein the personal area network transceiver comprises one of: an IEEE-802.15.3x transceiver, an MB-OFDM transceiver, a UWB transceiver, a wireless USB transceiver, an IEEE-802.11x transceiver, and a Bluetooth transceiver.

9. The mobile terminal as set forth in claim 1, further comprising a second transceiver capable of communicating with a wireless network.

10. The mobile terminal as set forth in claim 9, wherein the controller retrieves the multimedia data from a server via the second transceiver and the wireless network.

11. The mobile terminal as set forth in claim 9, wherein the controller compares the display parameter information associated with the remote display device to the display parameter information associated with the local display in order to determine which of the remote display device and the local display is better suited to a multimedia application executed by the mobile terminal.

12. The mobile terminal as set forth in claim 11, wherein the controller is capable of communicating with a remote user input device via the first transceiver.

13. The mobile terminal as set forth in claim 12, wherein the remote user input device comprises a wireless keyboard.

14. The mobile terminal as set forth in claim 12, wherein the controller is capable of prompting an operator of the mobile terminal for permission to transmit the multimedia data to the remote display device via the first transceiver.

15. The mobile terminal as set forth in claim 9, wherein the first transceiver comprises a personal area network transceiver.

16. The mobile terminal as set forth in claim 15, wherein the personal area network transceiver comprises one of: an IEEE-802.15.3x transceiver, an MB-OFDM transceiver, a UWB transceiver, a wireless USB transceiver, an IEEE-802.11x transceiver, and a Bluetooth transceiver.

17. The mobile terminal as set forth in claim 9, wherein the second transceiver comprises one of an IS-2000 transceiver, a 1xEV-DO transceiver, a 1xEV-DV transceiver, a GSM/GPRS/EDGE transceiver, a 3GPP UTRAN transceiver, an HSDPA/HSUPA transceiver, a 3GPP EUTRAN transceiver, a TD-CDMA transceiver, a WiBro transceiver, a WiMAX transceiver, an IEEE-802.16x transceiver, an IEEE-802.20 transceiver, and an IEEE-802.11x transceiver.

18. A method of operating a remote terminal comprising the steps of:
transmitting multimedia data to a local display of the remote terminal;
detecting the presence of a remote display device;
establishing a wireless communication link with the remote display device;
comparing display parameter information associated with the remote display device to display parameter information associated with the local display; and
in response to the comparison, transmitting the multimedia data to the remote display device.

19. The method as set forth in claim 18, further comprising the step of prompting an operator of the mobile terminal for permission to transmit the multimedia data to the remote display device.

20. The method as set forth in claim 18, further comprising the step of retrieving the multimedia data from one of: 1) a memory associated with the mobile terminal; and 2) a wireless network with which the mobile terminal is capable of communicating.

21. A mobile terminal comprising a local display capable of displaying multimedia data, wherein the mobile terminal is capable of receiving multimedia via a first wireless interface and transmitting the received multimedia to an external display via a second wireless interface.

22. The mobile terminal as set forth in claim 21, wherein the mobile terminal is further capable of determining if the quality of the external display is superior to the quality of the local display.

23. The mobile terminal as set forth in claim 22, wherein the mobile terminal transmits the received multimedia to the external display via the second wireless interface in response to a determination that the quality of the external display is superior to the quality of the local display.

24. The mobile terminal as set forth in claim 23, wherein the second wireless interface comprises one of: an IEEE-802.15.3x interface, an MB-OFDM interface, a UWB interface, a wireless USB interface, an IEEE-802.11x interface, and a Bluetooth interface.

25. The mobile terminal as set forth in claim 24, wherein the first wireless interface comprises one of: an IS-2000 interface, a 1xEV-DO interface, a 1xEV-DV interface, a GSM/GPRS/EDGE interface, a 3GPP UTRAN interface, an HSDPA/HSUPA interface, a 3GPP EUTRAN interface, a TD-CDMA interface, a WiBro interface, a WiMAX interface, an IEEE-802.16x interface, an IEEE-802.20 interface, and an IEEE-802.11x interface.
